(19) United States
(12) Patent Application Publication
(10) Pub. No.: US 2009/0055264 A1
(43) Pub. Date: Feb. 26, 2009

(54) PURCHASING INCENTIVE INITIATIVE

(76) Inventors: Donald M. Wolfson, Atlantic Beach, FL (US); Richard J. Wolfson, St. Augustine, FL (US)

Correspondence Address: HOLLAND & KNIGHT LLP, 10 ST. JAMES AVENUE, 11th Floor, BOSTON, MA, 02116-3889, US

(21) Appl. No.: 12/045,558

(22) Filed: Mar. 10, 2008

Related U.S. Application Data
(60) Provisional application No. 60/894,013, filed on Mar. 9, 2007.

(51) Int. Cl. G06Q 30/00

(52) U.S. Cl. 705/14

(57) ABSTRACT

A method of buying a vehicle. A subscriber defines a selected tier chosen from one or more available tiers within an incentive program. The subscriber may browse a vehicle database that lists one or more vehicles available for sale from a seller and may select a vehicle from the vehicles listed within the vehicle database. An incentive program certificate is issued to the subscriber for the selected vehicle, which defines a sale price for the selected vehicle based, at least in part, upon the selected tier and enables the subscriber to purchase the specific vehicle from the seller.

### CROSS-REFERENCE TO RELATED APPLICATIONS

This application claims priority to provisional application Ser. No. 60/894,013, filed on Mar. 9, 2007, entitled “PURCHASING INCENTIVE INITIATIVE” the entire contents of which are incorporated herein.

### FIELD OF THE INVENTION

The present invention relates to a purchasing incentive initiative, and more specifically a vehicle purchasing incentive initiative.

### BACKGROUND

In the field of purchasing, perks are often used to initiate or invigorate increased sales. Perks are often used with respect to consumer goods and services to enable a consumer to pay a lower price for the goods or service. Often today, such perks are sought after by employers as new and innovative benefits to give to their employees.

Further, many consumers shop for goods using the internet. Often, consumers use the internet as a tool to compare prices on specific products for which they are looking to purchase. For example, many car dealers post its current vehicle inventory and the lowest advertised prices for those vehicles. A consumer may search the vehicle inventory and lowest advertised prices of dealers that are local to the consumer. However, while searching the local dealers in this manner provides the consumer with the lowest advertised prices available to the general public at that time, being an individual consumer does not give the consumer any buying power or guarantee that those prices are truly the lowest prices available from the dealer. In fact, a consumer often must then go down to the dealer and negotiate, or “haggle,” for a lower price.

### SUMMARY

The present invention provides methods and apparatus, including computer program products, for an automotive purchasing incentive initiative.

In general, in one aspect, the implementation of the disclosure features a method of buying a vehicle including a subscriber defining a selected tier chosen from one or more available tiers within an incentive program. The subscriber may browse a vehicle database that lists one or more vehicles available for sale from a seller and may select a vehicle from the vehicles listed within the vehicle database. An incentive program certificate is issued to the subscriber for the selected vehicle, which defines a sale price for the selected vehicle based, at least in part, upon the selected tier and enables the subscriber to purchase the specific vehicle from the seller.

One or more of the following features may be included. The seller may be enabled to offer additional incentives to the subscriber. The additional incentives may include a rebate, a cash-back incentive, a credit balance on a cash card, or a gift card to another retailer. The subscriber may be an employee. A personal identification number may be assigned to the subscriber that enables the subscriber of the incentive program to browse the vehicle database. The vehicle database may be a dealer database, a new vehicle database, a fleet vehicle database, or a pre-owned vehicle database.

In general, in another aspect, the implementation of the disclosure features a computer program product residing on a computer readable medium that has a plurality of instruction stored on it. The instructions are executed by a processor. The instructions cause the processor to perform operations that enable a method of buying a vehicle. The method includes a subscriber defining a selected tier chosen from one or more available tiers within an incentive program. The subscriber may browse a vehicle database that lists one or more vehicles available for sale from a seller and may select a vehicle from the vehicles listed within the vehicle database. An incentive program certificate is issued to the subscriber for the selected vehicle, which defines a sale price for the selected vehicle based, at least in part, upon the selected tier and enables the subscriber to purchase the specific vehicle from the seller.

One or more of the following features may be included. The seller may be enabled to offer additional incentives to the subscriber. The additional incentives may include a rebate, a cash-back incentive, a credit balance on a cash card, or a gift card to another retailer. The subscriber may be an employee. A personal identification number may be assigned to the subscriber that enables the subscriber of the incentive program to browse the vehicle database. The vehicle database may be a dealer database, a new vehicle database, a fleet vehicle database, or a pre-owned vehicle database.

Other features and advantages of the invention are apparent from the following description, and from the claims.

### BRIEF DESCRIPTION OF THE DRAWINGS

FIG. 1 is block diagram of a purchasing incentive initiative system.

Like reference numbers and designations in the various drawings indicate like elements.

### DETAILED DESCRIPTION

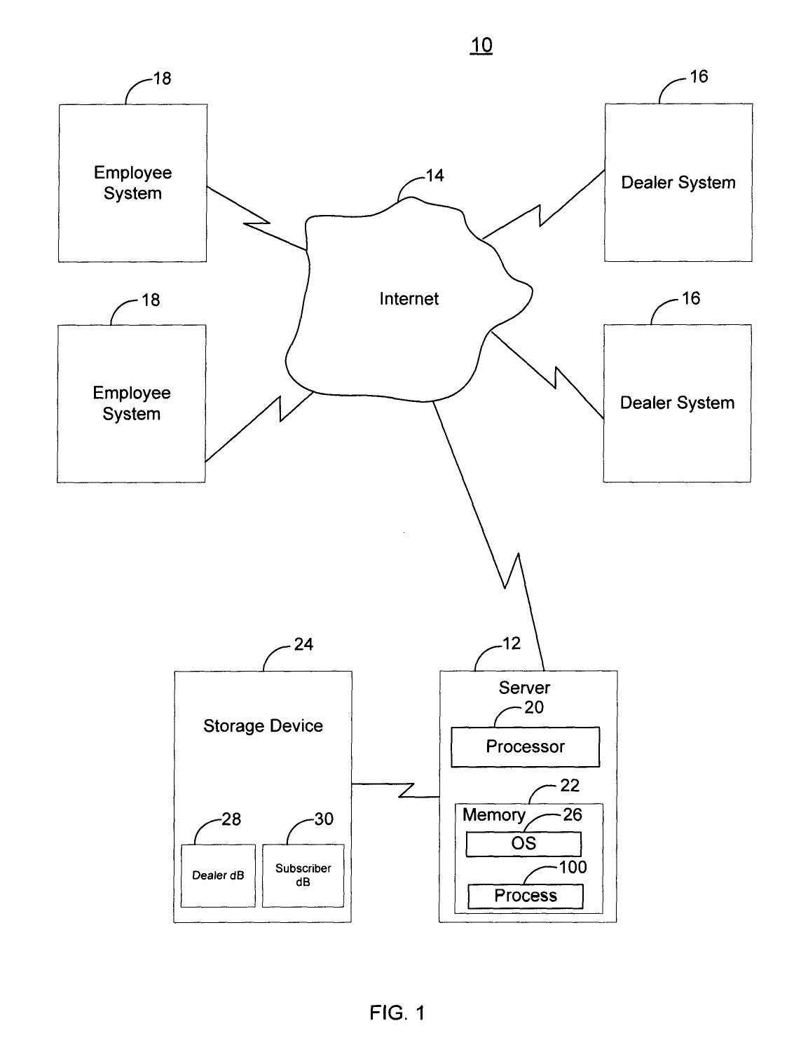

As shown in FIG. 1, a purchasing incentive initiative system 10 includes a server system 12 linked to a publicly accessible network of interconnected computer networks 14, i.e., the Internet. The system 10 includes one or more dealer systems 16 linked to the Internet 14 and one or more subscriber systems 18 linked to the Internet 14. The server system 12 includes a processor 20, memory 22 and a storage device 24. Memory 22 includes an operating system (OS) 26, such as Linux or Windows®, and a purchasing incentive initiative process 100, described below. The storage device 24 includes a dealer database 28 and a subscriber database 30. The dealer database 28 stores information relating to the dealer systems 16, such as name, address, automobile inventories, and so forth. The subscriber database 30 stores information relating to subscribers, such as name, address, place of employment, and so forth.

In one particular example, employees and employee relatives of a particular subscribing employer are the subscribers and are listed in the subscriber database 30. Subscribing employers subscribe to provide their employees and employee relatives with access the purchasing incentive initiative process 100 and are typically assigned a security access identification such as a password or personal identification number (PIN). Dealers subscribe to the purchasing incentive initiative process 100 to be listed in the dealer database 28 and to offer the purchasing incentive initiative process 100 to the subscribing employers and their employees or employee relatives who represent potential purchasers of the dealers' automobiles.

The purchasing incentive initiative process 100 is about providing a benefit to employers to offer to their employees as a benefit of employment (with the benefit being assistance in finding an automobile at a favorable price not generally available to the general public or receiving favorable incentives in connection with the purchase of an automobile not generally available to the general public), and about providing a means for dealers and/or the operator of the purchasing incentive initiative system to offer incentive purchasing programs and deals to a selected number of targeted potential purchasers. The purchasing incentive initiative process 100 supports an employee auto-buying program that enables an employee (i.e., subscriber) to purchase a new or used vehicle at the lowest Internet price available through the dealers listed in the dealer database 28.

The dealers listed in the dealer database 28 guarantee subscribers listed in the subscriber database 30 a corporate price on a vehicle purchase and may offer certain incentives. This price and the offered incentives may be adjusted depending on the relationship of the subscriber and/or the subscriber's employer to a particular dealer. The savings granted to the subscribers in the subscriber database 30 are those typically available only to volume buyers, not individual purchasers. Buyers, i.e., subscribers, receive all factory rebates and other incentives in place at the time of a purchase or lease.

The purchasing incentive initiative process 100 is a dealer discount program and not a manufacturer's discount program. Savings are based on the best Internet price being offered by participating dealers listed in the dealer database 28. Dealers contractually agree to offer savings below their most competitive Internet price offered to the general public or to offer incentives not offered to the general public. For example, savings can range from at least $100 below the best Internet price for new vehicles and $250 below the posted internet selling price for pre-owned vehicles.

In a particular example, the storage device 24 includes a new vehicle database. The new vehicle database is accessible to subscribers and includes information about vehicles that interest the particular subscriber. Prices that can appear in the new vehicle database are used for information purposes only and not as price quotes from the participating dealers in the dealer database 28. Prices are provided directly to subscribers by either a dealer Internet sales manager or a dealer program manager.

In another example, the storage device 24 may contain a fleet vehicle database in which fleet vehicles, such as formal rental automobiles, are listed and offered for sale to subscribers listed in the subscriber data base 30.

In another example, the storage device 24 may contain a pre-owned vehicle database in which pre-owned vehicles are listed and offered for sale to subscribers listed in the subscriber data base 30.

In another particular example, prices on vehicles are offered in discounted tiers and/or incentives are offered in various increasing tiers, depending on the seller's choice with respect to a particular employer and/or the operator of the system's choice to encourage a particular purchase. A seller could be a dealer, fleet owner or any owner of a new or pre-owned vehicle. A rebate, such as cash-back or a credit balance on a cash card, to a subscriber who purchases an automobile at a traditional “no haggle price” (understood usually as a non-negotiable, fixed price for any vehicle in a fleet) may also be made available by the seller and/or the operator (or a combination of the two) to encourage a sale.

Embodiments of the invention can be implemented in digital electronic circuitry, wireless technologies, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

What is claimed is:

1. A method of buying a vehicle comprising
enabling a subscriber to define a selected tier chosen from a plurality of available tiers within an incentive program;
enabling the subscriber to browse a vehicle database, wherein the vehicle database defines one or more vehicles available for sale from a seller;
enabling the subscriber to define a selected vehicle chosen from the one or more vehicles defined within the vehicle database;
issuing an incentive program certificate to the subscriber for the selected vehicle, wherein the incentive program certificate:
defines a sale price for the selected vehicle based, at least in part, upon the selected tier, and
enables the subscriber to purchase the specific vehicle from the seller.

2. The method of claim 1 further comprising:
enabling the seller to offer one or more additional incentives to the subscriber.

3. The method of claim 2 wherein the one or more additional incentives are chosen from the group consisting of a rebate, a cash-back incentive, a credit balance on a cash card, and a gift card to another retailer.

4. The method of claim 1 wherein the subscriber is an employee.

5. The method of claim 1 wherein enabling a subscriber to browse a vehicle database includes:
assigning the subscriber a personal identification number that enables the subscriber of the incentive program to browse the vehicle database.

6. The method of claim 1 wherein the vehicle database is chosen from the group consisting of a dealer database, a new vehicle database, a fleet vehicle database, and a pre-owned vehicle database.

7. A computer program product residing on a computer readable medium that has a plurality of instruction stored thereon which, when executed by a processor, cause the processor to perform operations comprising:
enabling a subscriber to define a selected tier chosen from a plurality of available tiers within an incentive program;
enabling the subscriber to browse a vehicle database, wherein the vehicle database defines one or more vehicles available for sale from a seller;
enabling the subscriber to define a selected vehicle chosen from the one or more vehicles defined within the vehicle database;
issuing an incentive program certificate to the subscriber for the selected vehicle, wherein the incentive program certificate:
defines a sale price for the selected vehicle based, at least in part, upon the selected tier, and
enables the subscriber to purchase the specific vehicle from the seller.

8. The computer program product of claim 1 further comprising instructions for:
enabling the seller to offer one or more additional incentives to the subscriber.

9. The computer program product of claim 2 wherein the one or more additional incentives are chosen from the group consisting of a rebate, a cash-back incentive, a credit balance on a cash card, and a gift card to another retailer.

10. The computer program product of claim 1 wherein the subscriber is an employee.

11. The computer program product of claim 1 wherein the instructions for enabling a subscriber to browse a vehicle database include instructions for:
assigning the subscriber a personal identification number that enables the subscriber of the incentive program to browse the vehicle database.

12. The computer program product of claim 1 wherein the vehicle database is chosen from the group consisting of a dealer database, a new vehicle database, a fleet vehicle database, and a pre-owned vehicle database.
